(19) United States
(12) Patent Application Publication
(10) Pub. No.: US 2024/0275203 A1
(43) Pub. Date: Aug. 15, 2024

(54) ENERGY DISTRIBUTION CONTROL FOR SMART GRID

(71) Applicant: IHI Corporation, Tokyo (JP)

(72) Inventors: Misako KONISHI, Tokyo (JP); Akinobu INAMURA, Tokyo (JP)

(21) Appl. No.: 18/439,774

(22) Filed: Feb. 13, 2024

(30) Foreign Application Priority Data
Feb. 15, 2023 (JP) 2023-021680

(51) Int. Cl. H02J 13/00; H02J 3/00

(52) U.S. Cl. CPC H02J 13/00002; H02J 3/004; H02J 13/00001

(57) ABSTRACT

A smart grid system that controls a supply of energy to a plurality of user devices, includes an energy supply device to obtain from an external energy source energy that is assigned an external energy unit value, a storage device to temporarily store the energy for distribution to the plurality of user devices, at least one control device and a filling device. The at least one control device sets an internal energy unit value based on either the external energy unit value or a predefined unit value, acquires a trigger command based on an amount of energy stored in the storage device, and modifies the internal energy unit value in response to acquiring the trigger command. The filling device distributes the energy to the plurality of user devices at the modified internal energy unit value.

### CROSS-REFERENCE TO RELATED APPLICATIONS

This application claims the benefit of priority from Japanese Patent Application No. 2023-021680, filed on Feb. 15, 2023, the entire contents of which are incorporated herein by reference.

### BACKGROUND

A mechanism for charging according to electric charging and discharging of an electric vehicle or the like is known. For example, Japanese Patent No. 5606406 discloses a technique of supplying electric power between an electric charging-discharging station and an electric vehicle. In the technique disclosed in Japanese Patent No. 5606406, the value of the electric power is determined on the basis of a remaining electric power amount of the electric vehicle and time of day. The value determination disclosed in Japanese Patent No. 5606406 does not take into account the remaining electric power amount of the electric charging-discharging station. For example, when the remaining electric power amount of the electric charging-discharging station decreases, generally, electric power is procured from an external electric power system or the like. The procurement value at this time is sometimes higher.

Japanese Unexamined Patent Publication No. 2014-138534 discloses a technique of comparing value information regarding a storage battery with value information regarding a commercial system and promotes the use of affordable electric power. The technique disclosed in Japanese Unexamined Patent Publication No. 2014-138534 uses electric power of the commercial system when electric power of the storage battery is equal to or less than a threshold. In the technique disclosed in Japanese Unexamined Patent Publication No. 2014-138534, the value information on the commercial system is used in correspondence with the use of electric power of the commercial system on the basis of electric power of the storage battery. In other words, when electric power of the storage battery is equal to or less than the threshold, the price information on the commercial system is used regardless of whether or not electric power is affordable.

### SUMMARY

A charging device (or control device) according to an example, sets an internal unit value serving as a unit value of energy available inside a smart grid for distribution to user devices.

The example charging device (or control device) includes an acquisition unit configured to acquire an external unit value serving as a unit value of the energy exchanged outside the smart grid, a setting unit configured to set a basic internal unit value for the internal unit value by regarding a unit value linked with the external unit value or a predefined unit value as the basic internal unit value, a command reception unit configured to acquire a command generated using an energy remaining amount serving as a remaining amount of the energy inside the smart grid, and a correction unit configured to calculate a corrected internal unit value obtained by correcting the internal unit value with acquisition of the command as a trigger, and set the corrected internal unit value for the internal unit value.

### BRIEF DESCRIPTION OF DRAWINGS

FIG. 1 is a block diagram illustrating an example of an overall configuration of a smart grid system.

FIG. 2 is a block diagram illustrating an example of a functional configuration of a control device (or charging device).

FIG. 3 is a diagram illustrating an example of a value list.

FIG. 4 is a flowchart illustrating an example of the operation of the smart grid system.

FIG. 5 is a flowchart illustrating another example of the operation of the smart grid system.

FIG. 6 is a diagram illustrating an example of a hardware configuration related to the smart grid system.

### DETAILED DESCRIPTION

An example control device (or charging device) or smart grid system sets an internal unit value (or internal energy unit value) serving as a unit value of energy available in a smart grid for distribution to user devices.

The example charging device (or control device) includes, an acquisition unit configured to acquire an external unit value (or external energy unit value) serving as a unit value of the energy exchanged outside the smart grid, a setting unit configured to set a basic internal unit value for the internal unit value by regarding a unit value linked with the external unit value or a predefined unit value as the basic internal unit value, a command reception unit configured to acquire a command generated using an energy remaining amount serving as a remaining amount of the energy inside the smart grid, and a correction unit configured to calculate a corrected internal unit value obtained by correcting the internal unit value with acquisition of the command as a trigger, and set the corrected internal unit value for the internal unit value.

An example charging method (or control method) is executed by an example charging device including at least one processor.

The example charging method includes acquiring an external unit value serving as a unit value of energy exchanged outside a smart grid, setting a basic internal unit value for an internal unit value serving as a unit value of the energy available inside the smart grid for distribution to user devices, by regarding a unit value linked with the external unit value or a predefined unit value as the basic internal unit value, acquiring a command generated using an energy remaining amount serving as a remaining amount of the energy inside the smart grid, calculating a corrected internal unit value obtained by correcting the internal unit value with acquisition of the command as a trigger, and setting the corrected internal unit value for the internal unit value.

In the example charging device and the example charging method, the unit value linked with the external unit value or the predefined unit value is regarded as the basic internal unit value, and the internal unit value is set using the basic internal unit value. Then, with the acquisition of the command as a trigger, the corrected internal unit value with the internal unit value corrected is calculated, and the internal unit value is set using the corrected internal unit value. That is, the internal unit value of the energy available in the smart grid is dynamically set so as to improve the supply of the energy in the smart grid for the user devices.

The internal unit value may be a value list indicating unit values for each time of day (e.g., time intervals). The setting unit may set the basic internal unit value for the internal unit value for each time of day. The correction unit may calculate the corrected internal unit value obtained by correcting the internal unit value for each time of day and set the corrected internal unit value for the internal unit value for each time of day. By setting the basic internal unit value and the corrected internal unit value for the internal unit value for each time of day, the unit value of energy can be set more appropriately.

The command may have been generated using the energy remaining amount predicted for a future time of day. The correction unit may calculate the corrected internal unit value obtained by correcting the internal unit value at the future time of day and set the corrected internal unit value for the internal unit value at the future time of day. According to such a configuration, the internal unit value at the future time of day is determined in advance so as to more easily schedule a trade (e.g., supply or acquiring of the energy in the smart grid) and thus improve convenience for the user. In addition, since the unit value of energy can be set more appropriately, the balance between demand and supply of energy can be more easily controlled so as to promote a better distribution of the energy from the smart grid.

The command may have been generated when the energy remaining amount indicates a surplus. The correction unit may calculate the corrected internal unit value by using a unit value lower than an average of the internal unit values in a predetermined period. According to such a configuration, when the energy remaining amount indicates a surplus, the internal unit value is set lower than the internal unit value set at a normal time. This can encourage the user to supply energy to the smart grid. Since the unit value (e.g., unit price) of energy can be set more appropriately, the balance between demand and supply of energy can be more easily controlled so as to promote a better distribution of the energy from the smart grid.

The command may have been generated when the energy remaining amount indicates a shortage of energy remaining in the smart grid. The correction unit may calculate the corrected internal unit value by using a unit value higher than an average of the internal unit values in a predetermined period. According to such a configuration, when the energy remaining amount indicates a shortage, the internal unit value is set higher than the internal unit value set at a normal time. This can encourage the user to acquire energy from the smart grid. Since the unit value (e.g., unit price) of energy can be set more appropriately, the balance between demand and supply of energy can be more easily controlled so as to promote a better distribution of the energy from the smart grid.

The example charging device may further include a transmission unit configured to transmit the internal unit value to a terminal of the user of the smart grid in response to setting of the corrected internal unit value for the internal unit value. This can encourage the user to transfer energy between the smart grid and the user device. Since the unit value (e.g., unit price) of energy can be set more appropriately, the balance between demand and supply of energy can be more easily controlled so as to promote a better distribution of the energy from the smart grid.

The energy may include electric power, hydrogen, ammonia, or heat. Examples of the charging device can support pay-per-use schemes for various energy types.

Hereinafter, with reference to the drawings, the same elements or similar elements having the same function are denoted by the same reference numerals, and redundant description will be omitted.

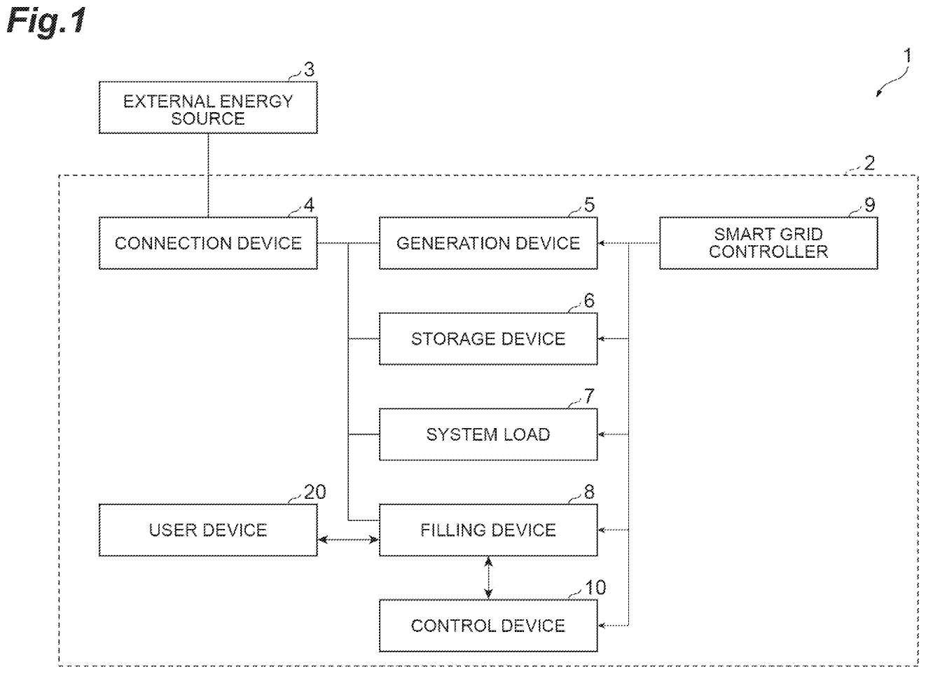

FIG. 1 is a block diagram illustrating an example of an overall configuration of a charging system 1. The charging system 1 is applied to a transfer of energy with a smart grid (or smart grid system) 2. Examples of energy supplied by the smart grid system 2 include, but are not restricted to, electric power, hydrogen, ammonia, and heat. According to some examples of the present disclosure, the energy is described as electric power. A situation where charging is performed in association with electric charging or discharging of an electric vehicle will be described. In the charging system 1, for example, energy is transferred at a first unit value set on the previous day or the like. According to circumstances in the smart grid 2, in the charging system 1, energy is transferred at a second unit value obtained by correcting the first unit value.

The smart grid 2 is connected to an external energy source 3, such as an energy market in which energy can be sold and purchased. The energy source 3 is, for example, an electric power system. The smart grid 2 is supplied with energy from the energy source 3. The smart grid 2 may or may not supply energy to the energy source 3.

The smart grid 2 includes a connection device 4, a generation device 5, a storage device 6, a system load (or consumer) 7, a filling device 8, a smart grid controller (or control device) 9, and a control device (or charging device) 10. The connection device 4, the generation device 5, the storage device 6, the system load 7, and the filling device 8 are connected to each other by an energy supply network. For example, the connection device 4, the generation device 5, the storage device 6, the system load 7, and the filling device 8 are interconnected to each other by electric power lines.

The connection device 4 supplies energy supplied from the energy source 3 into the smart grid 2. The connection device 4 is, for example, an electric power receiving panel. In one example, the connection device 4 controls electric power distribution to each device in the smart grid 2 and also supplies electric power to each device.

The generation device 5 is a facility that generates energy in the smart grid 2. For example, the generation device 5 is a facility that generates electric power with renewable energy such as sunlight or wind power. The generation device 5 is not restricted to a facility that uses renewable energy. In one example, the generation device 5 is a solar electric power generation facility. The generation device 5 includes a solar panel and a power conditioning system (PCS). The PCS converts a direct current generated by the solar panel into an alternating current. The generation device 5 supplies electric power into the smart grid 2.

The storage device 6 is a device that stores energy in the smart grid 2. The storage device 6 supplies energy into the smart grid 2 in response to control from the smart grid controller 9. The storage device 6 is, for example, a storage battery system. The storage device 6 includes a storage battery, a storage battery PCS that converts a direct current of the storage battery into an alternating current, and a monitoring device for a remaining amount of the storage battery. The storage battery is a secondary battery such as a lithium ion battery, a lead storage battery, or a redox flow battery. The storage device 6 may be an energy storage device such as a flywheel, a compressed air energy storage (CAES) facility, or a high capacity capacitor. The storage device 6 can function as an electric power adjustment device when adjusting exchange of electric power between the smart grid 2 and the external energy source 3.

The system load 7 consumes energy in the smart grid 2. The system load 7 is, for example, a load that consumes electric power. The system load 7 may start or stop the operation in response to control from the smart grid controller 9. The system load 7 may start or stop the operation independently of the smart grid controller 9.

The filling device 8 exchanges energy with a user device 20 inside the smart grid 2. The filling device 8 is, for example, an electric charger for an electric vehicle. The user device 20 is, for example, an electric vehicle. For example, electric power may be sold or purchased via the filling device 8, for example on a pay-per-use basis. In one example, the filling device 8 sells electric power to supply electric power to the electric vehicle. In another example, the filling device 8 purchases electric power to acquire (or receive) electric power supplied from the electric vehicle.

The smart grid controller 9 controls or monitors each device in the smart grid 2. The smart grid controller 9 is, for example, an energy management system (EMS). For example, the smart grid controller 9 controls the energy generation amount of the generation device 5 and the start and stop of the operation of the generation device 5. The smart grid controller 9 acquires the remaining amount of energy stored in the storage device 6. The smart grid controller 9 controls the amount of energy supplied by the storage device 6. The smart grid controller 9 controls the start and stop of the operation of the system load 7. The smart grid controller 9 acquires the amount of energy consumed by the system load 7. The smart grid controller 9 acquires the amount of energy supplied from or received by the filling device 8.

The smart grid controller 9 generates a command (or trigger command) on the basis of the energy remaining amount. The command is a DR command indicating a so-called demand response (DR). It can also be said that the command is a trigger for adjusting the balance between demand and supply for the energy users. The smart grid controller 9 transmits the command to the control device 10.

The smart grid controller 9 may generate the command when the energy remaining amount indicates a surplus or shortage of the energy remaining available in the smart grid, for example based on a comparison with a predetermined range. The smart grid controller 9 may generate the command by including various kinds of information. For example, the smart grid controller 9 may include, in the command, information indicating a surplus of the energy remaining amount or information indicating a shortage of the energy remaining amount. The smart grid controller 9 may include time information in the command. For example, the smart grid controller 9 may include, in the command, information indicating the current time or information indicating a future time of day associated with the energy remaining amount.

The smart grid controller 9 may generate the command on the basis of the energy remaining amount predicted for a future time of day. The smart grid controller 9 may generate the command a certain time before a future time of day. The smart grid controller 9 may calculate a probability that the command is generated, for example a probability that a surplus or shortage will occur in the energy remaining amount at a given time, and generate the command when the probability is equal to or higher than a certain value. A method for calculating the probability is not limited. For example, the smart grid controller 9 may calculate the probability on the basis of one or more of a state of charge (SOC) of the storage battery, an energy generation amount or consumption amount, a slope of change in the state of charge of the storage battery, and the like.

For example, the smart grid controller 9 may generate the command in which the energy remaining amount indicates a surplus when the state of charge of the storage battery has a certain value or more as compared with a normal time. The smart grid controller 9 may generate the command in which the energy remaining amount indicates a shortage when the SOC has a certain value or less as compared with a normal time. The energy remaining amount at the normal time may be an average value or the like of the energy remaining amount in a predetermined period.

For example, the smart grid controller 9 may generate the command on the basis of the energy generation amount by the generation device 5. For example, in a case where the generation device 5 is a facility that generates electric power with renewable energy such as sunlight or wind power, the amount of electric power generation varies depending on the air temperature, the amount of sunlight, the wind speed, and/or the like. The smart grid controller 9 may generate the command on the basis of whether the amount of electric power generation by the generation device 5 is greater or less than the amount of electric power generation at a normal time. The amount of electric power generation at the normal time may be an average value or the like of the amount of electric power generation in a predetermined period.

For example, the smart grid controller 9 may generate the command on the basis of the amount of energy consumed by the system load 7. For example, the smart grid controller 9 may generate the command on the basis of whether the consumption amount by the system load 7 is greater or less than the consumption amount at a normal time. The consumption amount at the normal time may be an average value or the like of the consumption amount in a predetermined period.

For example, the smart grid controller 9 may generate the command on the basis of a slope of change in the storage rate of the storage device 6. For example, the smart grid controller 9 may predict the time at which the state of charge or the state of discharge exceeds a predetermined threshold on the basis of a slope of change in the state of charge or the state of discharge of the storage battery.

The control device 10 sets the internal unit value serving as a unit value of energy available for distribution from the smart grid 2. The control device 10 sets the internal unit value [yen/minute] to be exchanged between the filling device 8 and the user device 20. The internal unit value may be, for example, a value list indicating unit values for each time (or time interval) of day. For example, the control device 10 sets the internal unit value for each time (or time interval) of day. The expression of the internal unit value is not restricted to this internal unit value for each time of day, and the internal unit value may have a single unit value regardless of the time of day. The control device 10 may display the time of day corresponding to the current time and the internal unit value at that time of day on a display device included in the control device 10. The control device 10 may display the internal unit value on a display device of the filling device 8.

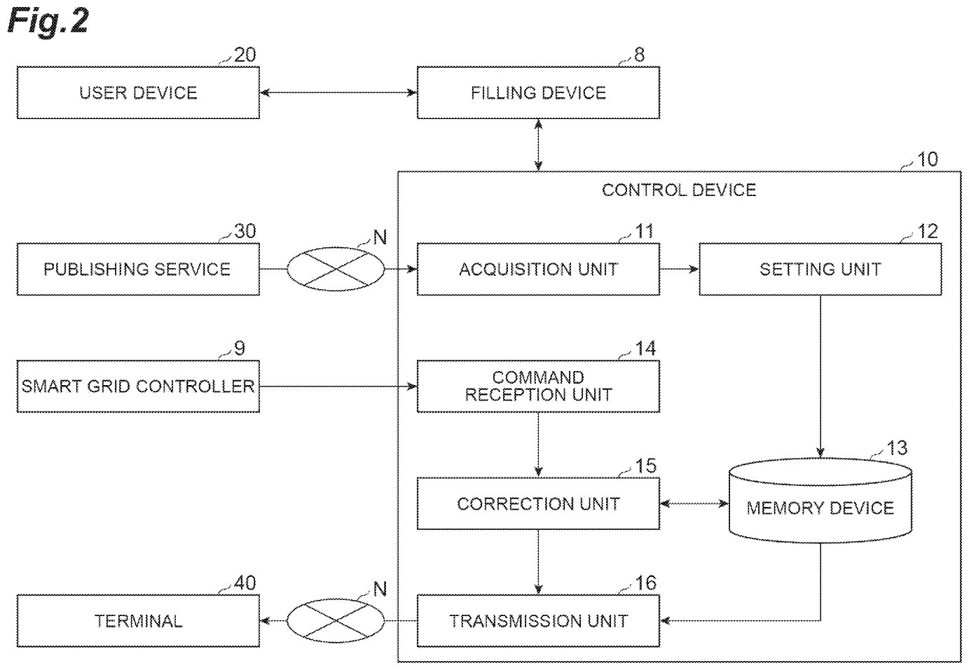

FIG. 2 is a block diagram illustrating an example of a functional configuration of the control device 10. The control device 10 includes, as functional elements, an acquisition unit 11, a setting unit 12, a memory device 13, a command reception unit 14, a correction unit 15, and a transmission unit 16.

The acquisition unit 11 acquires the external unit value serving as a unit value of energy exchanged outside the smart grid 2. The acquisition unit 11 acquires the external unit value from a publishing service 30, for example, via a network N such as the Internet. The external unit value may be a value list indicating unit values for each time of day. In one example, the external unit value is an electric power value list published by the Japan Electric Power Exchange. In the electric power value list, the unit values of electric power [yen/kWh] for every 30 minutes are indicated for 24 hours on the next day. The acquisition unit 11 acquires the external unit value at any timing such as once a day as an example, but is not restricted to this.

The setting unit 12 sets the basic internal unit value (or default value) for the internal unit value by regarding a unit value linked with the external unit value or a predefined unit value as the basic internal unit value. The setting unit 12 determines the unit value linked with the external unit value as the basic internal unit value on the basis of an external unit value linkage setting indicating whether or not the unit value is linked with the external unit value. For example, the external unit value linkage setting is set by an operator of the smart grid 2, an owner of the filling device 8, or the like. When the external unit value linkage setting is activated, so as to indicate for example “to be linked with the external unit value”, the setting unit 12 determines the unit value linked with the external unit value as the basic internal unit value. For example, the setting unit 12 may determine a unit value obtained by correcting a basic unit value serving as a reference value by using the external unit value, as the basic internal unit value. The basic unit value may be a predefined unit value, an average of internal unit values in a predetermined period, or the like. The setting unit 12 may determine a unit value linearly linked with the external unit value as the basic internal unit value. The setting unit 12 may determine a unit value linked with the external unit value as the basic internal unit value using a threshold. The setting unit 12 may determine the basic internal unit value at a future time of day.

When the external unit value linkage setting is deactivated, so as to indicate for example “not to be linked with the external unit value”, the setting unit 12 determines a predefined unit value as the basic internal unit value. The predefined unit value may be an average of the internal unit values in a predetermined period, or the like. The setting unit 12 may determine a unit value predefined for each time of day as the basic internal unit value.

The setting unit 12 sets the basic internal unit value for the internal unit value. The setting unit 12 may set the basic internal unit value for the internal unit value for each time of day. The setting unit 12 may set the internal unit value by saving the basic internal unit value in the memory device 13.

The memory device 13 is a non-transitory memory medium or a memory device that holds the internal unit value. The memory device 13 may be constructed as a single database or may be a set of a plurality of databases. The installation location of the memory device 13 is not limited. For example, the memory device 13 may be provided in a computer system different from the charging system 1.

The command reception unit 14 acquires the command generated using the energy remaining amount serving as a remaining amount of energy inside the smart grid 2. The command reception unit 14 receives the command from the smart grid controller 9.

The correction unit 15 calculates the corrected internal unit value obtained by correcting the internal unit value with the acquisition of the command as a trigger and sets the corrected internal unit value for the internal unit value. The correction unit 15 calculates the corrected internal unit value on the basis of a command linkage setting indicating whether or not the unit value is linked with the command. For example, the command linkage setting is set by an operator of the smart grid 2, an owner of the filling device 8, or the like. When the command linkage setting indicates “to be linked with the command”, the correction unit 15 calculates the corrected internal unit value. The correction unit 15 may calculate the corrected internal unit value obtained by correcting the internal unit value for each time of day. The correction unit 15 may calculate the corrected internal unit value obtained by correcting the internal unit value at a future time of day. When the command linkage setting indicates “not to be linked with the command”, the correction unit 15 may not calculate the corrected internal unit value.

The correction unit 15 sets the corrected internal unit value for the internal unit value. The correction unit 15 overwrites the internal unit value already set by the setting unit 12 with the corrected internal unit value. In other words, the correction unit 15 corrects the internal unit value already set by the setting unit 12 with the corrected internal unit value. The correction unit 15 may set the corrected internal unit value for the internal unit value for each time of day. The correction unit 15 may set the corrected internal unit value for the internal unit value at a future time of day. The correction unit 15 may set the internal unit value by saving the calculated corrected internal unit value in the memory device 13.

The correction unit 15 may set the corrected internal unit value according to the content of the command. In one example, the command may have been generated when the energy remaining amount indicates a surplus. The correction unit 15 may calculate the corrected internal unit value by using a unit value lower than an average of the internal unit values in a predetermined period. In another example, the command may have been generated when the energy remaining amount indicates a shortage. The correction unit may calculate the corrected internal unit value by using a unit value higher than an average of the internal unit values in a predetermined period.

A method for determining the basic internal unit value or the corrected internal unit value is not limited. In one example, the setting unit 12 may determine the basic internal unit value using following Formula (1). The correction unit 15 may determine the corrected internal unit value using following Formula (1).

$$Basic Internal Unit Value or Corrected Internal Unit Value [ yen / min ] = Basic Unit Value [ yen / min ] + Corrected Unit Value by External Unit Value [ yen / min ] \times External Unit Value Linkage Presence or Absence ( 1 or 0 ) \text{} + \text{} Command - Based Corrected Unit Value [ yen / min ] \times Command Linkage Presence or Absence ( 1 or 0 ) … \qquad ( 1 )$$

In Formula (1), the corrected unit value by the external unit value may be a unit value calculated by a predetermined ratio, a certain value, or the like for the external unit value. When the external unit value linkage setting indicates “to be linked with the external unit value”, the value of the external unit value linkage presence or absence may be “1”. When the external unit value linkage setting indicates “not to be linked with the external unit value”, the value of the external unit value linkage presence or absence may be “0”. When the command is not acquired, the value of the command-based corrected unit value may be “0”. For example, when the setting unit 12 sets the internal unit value for the next day, the basic internal unit value may be calculated by regarding the value of the command-based corrected unit value as “0”. The command-based corrected unit value may be a unit value according to the content of the command. In one example, the command-based corrected unit value may be different according to the command generated when the energy remaining amount indicates a surplus and the command generated when the energy remaining amount indicates a shortage. For example, in the case of the command generated when the energy remaining amount indicates a surplus, the command-based corrected unit value may have a negative value. In the case of the command generated when the energy remaining amount indicates a shortage, the command-based corrected unit value may have a positive value. When the set command linkage setting indicates “to be linked with the command”, the value of the command linkage presence or absence may be “1”. When the set command linkage setting indicates “not to be linked with the command”, the value of the command linkage presence or absence may be “0”.

The transmission unit 16 transmits the internal unit value, as an output value, to a terminal 40 of the user. For example, the transmission unit 16 may transmit the internal unit value to the terminal 40 via an electronic mail, a short message service (SMS), an advertisement through the Internet, or the like. The transmission unit 16 may transmit the internal unit value at a future time of day of the next day or the like, as the output value, to the terminal 40, for example. For example, the transmission unit 16 transmits the internal unit value set by the setting unit 12 to the terminal 40. The transmission unit 16 transmits the internal unit value to the terminal 40 in response to setting of the corrected internal unit value for the internal unit value. In the transmission of the internal unit value, the transmission unit 16 may cause to display the output value in a highlighted manner. The output value to be displayed may include the internal unit value at a future time of day for which the corrected internal unit value has been set, or a difference between the internal unit value and the corrected internal unit value.

The terminal 40 is a computer used by the user. The type and configuration of the terminal 40 are not limited. For example, the terminal 40 may be a personal computer, a sophisticated mobile phone (smartphone), a tablet terminal, or a wearable terminal.

The filling device 8 calculates a total value on the basis of the internal unit value and the amount of energy supplied from or received by the filling device 8. For example, the filling device 8 calculates the total value with the unit value [yen/minute] set for each time of day×the filling time of energy. The filling device 8 may display the time of day corresponding to the current time and the internal unit value at that time of day on the display device.

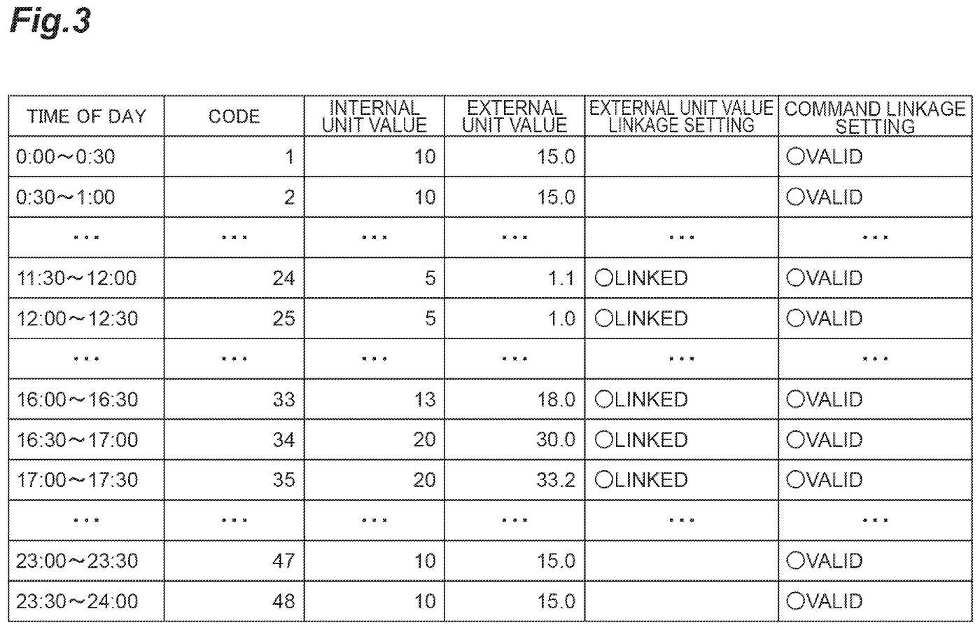

FIG. 3 is a diagram illustrating an example of the value list in which the internal unit values are set. FIG. 3 illustrates, for example, a value list in which the internal unit values for the next day are set. FIG. 3 illustrates the time of day, a code, the internal unit value, the external unit value, the external unit value linkage setting, and the command linkage setting.

In FIG. 3, the “time of day” denotes a span of time indicating every 30 minutes of 24 hours. The span of time is not restricted to 30 minutes and may indicate every hour. The “code” denotes 48 line numbers corresponding to the number of times of day. The “internal unit value” denotes a value of the internal unit value set for each time of day. The “external unit value” denotes a value of the external unit value for each time of day. The “external unit value linkage setting” indicates the setting content as to whether or not to link with the external unit value, for each time of day. For example, when the external unit value linkage setting is blank, the setting to not link with the external unit value is indicated. When the external unit value linkage setting has “∘ linked”, the setting to link with the external unit value is indicated. The external unit value linkage setting may be set for each time, day of the week, or unique day. The “command linkage setting” indicates the setting content as to whether or not to link with the command, for each time of day. For example, when the command linkage setting is blank, the setting to not link with the command is indicated. When the command linkage setting has “∘ valid”, the setting to link with the command is indicated.

In one example, the external unit value linkage setting has “∘ linked” at the time of day of “16:00 to 16:30”. At the time of day of “16:00 to 16:30”, the value “13” of the internal unit value is a value calculated as a unit value linked with the external unit value “18.0”.

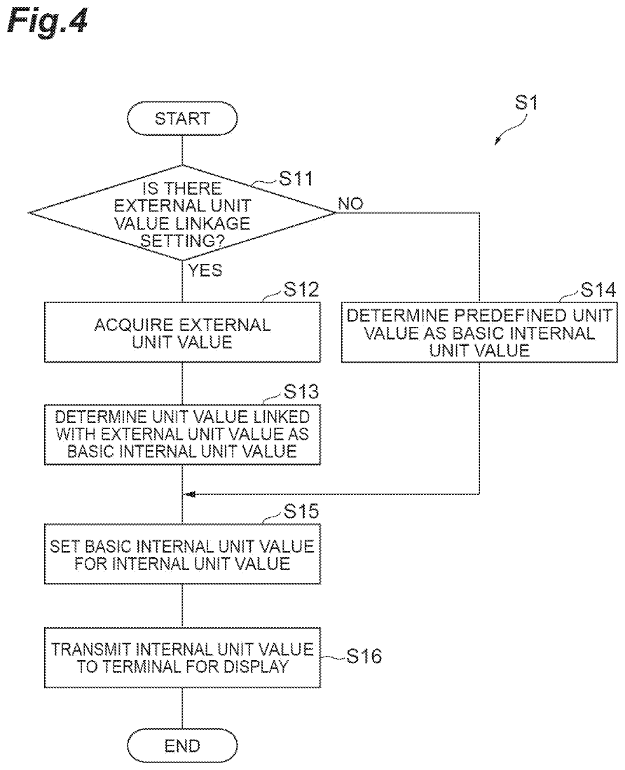

An operation of the control device 10 will be described with reference to FIG. 4, and an example of the control method will also be described. FIG. 4 is a flowchart illustrating an example of the operation of the control device 10, as a processing flow S1.

In step S11, when the external unit value linkage setting indicates “to be linked with the external unit value” (step S11: YES), the process proceeds to step S12. In step S11, when the external unit value linkage setting indicates “not to be linked with the external unit value”, the process proceeds to step S14.

In step S12, the acquisition unit 11 acquires the external unit value. For example, the acquisition unit 11 acquires the external unit value from the publishing service 30 via the network N. The external unit value may be a value list indicating unit values for each time of day.

In step S13, the setting unit 12 determines the unit value linked with the external unit value as the basic internal unit value. For example, the setting unit 12 may determine a unit value obtained by correcting the basic unit value serving as a reference by using the external unit value, as the basic internal unit value. The setting unit 12 may determine a unit value linked with the external unit value as the basic internal unit value for each time of day. The setting unit 12 may determine the internal unit value using Formula (1).

In step S14, the setting unit 12 determines a predefined unit value as the basic internal unit value. The predefined unit value may be an average of the internal unit values in a predetermined period, or the like. The setting unit 12 may determine a unit value predefined for each time of day as the basic internal unit value.

In step S15, the setting unit 12 sets the basic internal unit value for the internal unit value. The internal unit value may be a value list indicating unit values for each time of day. The setting unit 12 may set the basic internal unit value for the internal unit value for each time of day. For example, the setting unit 12 may set the basic internal unit values for each time of day in the value list as illustrated in FIG. 3. The setting unit 12 may set the internal unit value determined regardless of the time of day. The setting unit 12 may set the internal unit value by saving the basic internal unit value in the memory device 13.

In step S16, the transmission unit 16 transmits the internal unit value, as an output value, to the terminal 40 of the user. For example, the transmission unit 16 may transmit the internal unit value to the terminal 40 via an electronic mail, an SMS, an advertisement through the Internet, or the like. The transmission unit 16 may transmit the internal unit value at a future time of day of the next day or the like to the terminal 40, for example. For example, the transmission unit 16 transmits the internal unit value set by the setting unit 12 to the terminal 40.

The control device 10 may display the time of day corresponding to the current time and the output value corresponding to the internal unit value at that time of day, on the display device included in the control device 10. The control device 10 may display the internal unit value, as the output value, on the display device of the filling device 8.

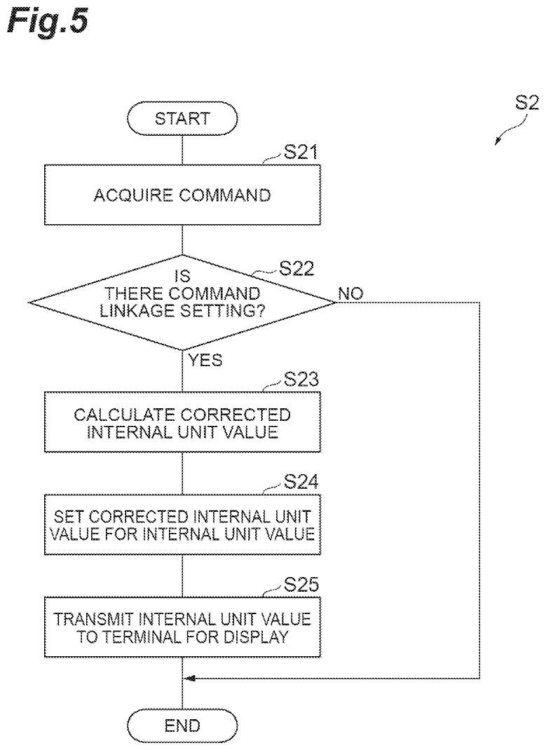

An operation of the control device 10 will be described with reference to FIG. 5, and an example of the control method will also be described. FIG. 5 is a flowchart illustrating another example of the operation of the control device 10, as a processing flow S2. In the processing flow S2, description will be given by assuming that the internal unit value has already been set by the setting unit 12.

In step S21, the command reception unit 14 acquires the command generated using the energy remaining amount. For example, the command reception unit 14 receives the command from the smart grid controller 9. For example, the command may have been generated on the basis of the energy remaining amount predicted for a future time of day. The command may have been generated on the basis of the current energy remaining amount. The command may have been generated when the energy remaining amount indicates a surplus. The command may have been generated when the energy remaining amount indicates a shortage.

In step S22, when the command linkage setting indicates “to be linked with the command” (step S22: YES), the process proceeds to step S23. When the command linkage setting indicates “not to be linked with the command” in step S22, the processing flow S2 ends.

In step S23, the correction unit 15 calculates the corrected internal unit value. The correction unit 15 may calculate the corrected internal unit value obtained by correcting the internal unit value for each time of day. The correction unit 15 may calculate the corrected internal unit value obtained by correcting the internal unit value at a future time of day. The correction unit 15 may calculate the corrected internal unit value obtained by correcting the internal unit value at the time of day corresponding to the current time. The correction unit 15 may calculate the corrected internal unit value using Formula (1).

The correction unit 15 may set the corrected internal unit value according to the content of the command. In one example, the command may have been generated when the energy remaining amount indicates a surplus. The correction unit 15 may calculate the corrected internal unit value by using a unit value lower than an average of the internal unit values in a predetermined period. In another example, the command may have been generated when the energy remaining amount indicates a shortage. The correction unit may calculate the corrected internal unit value by using a unit value higher than an average of the internal unit values in a predetermined period.

In step S24, the correction unit 15 sets the corrected internal unit value for the internal unit value. The correction unit 15 may set the corrected internal unit value for the internal unit value for each time of day. The correction unit 15 may set the corrected internal unit value for the internal unit value at a future time of day. For example, the correction unit 15 sets the corrected internal unit values for each time of day for the value list as illustrated in FIG. 3. The correction unit 15 may set the internal unit value by saving the calculated corrected internal unit value in the memory device 13.

In step S25, the transmission unit 16 transmits the internal unit value, as an output value, to the terminal 40 in response to setting of the corrected internal unit value for the internal unit value. In the transmission of the internal unit value, the transmission unit 16 may cause to display, in a highlighted manner, the internal unit value at a future time of day for which the corrected internal unit value has been set or a difference between the internal unit value and the corrected internal unit value.

The control device 10 may display the time of day corresponding to the current time and the output value corresponding to the internal unit value at that time of day, on the display device included in the control device 10. The control device 10 may display the internal unit value, as the output value, on the display device of the filling device 8.

### [Hardware Configuration]

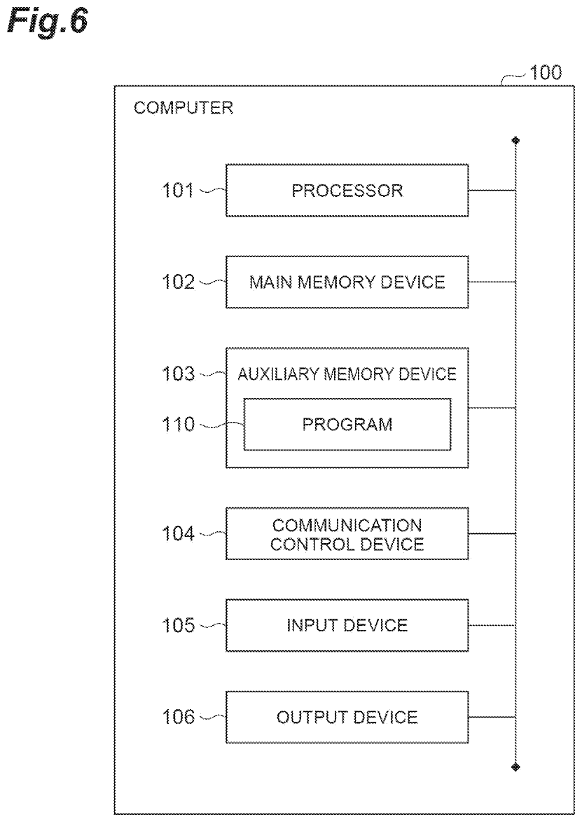

FIG. 6 is a diagram illustrating an example of a hardware configuration related to the charging system 1. FIG. 6 illustrates a computer 100 functioning as the control device 10. The computer 100 includes at least one processor 101, a main memory unit (or main memory device) 102, an auxiliary memory unit (or auxiliary memory device) 103, a communication control unit (or communication control device) 104, an input device 105, and an output device 106. The control device 10 may be formed by one or a plurality of computers 100 including the above-mentioned hardware components and software such as a program.

In a case where the control device 10 is provided by a plurality of computers 100, these computers 100 may be locally connected or may be connected via a communication network such as the Internet or an intranet. With this connection, one control device 10 is logically constructed.

The processor 101 executes an operating system, an application program, and/or the like. The processor 101 is, for example, a central processing unit (CPU). The main memory device 102 includes a read only memory (ROM) and a random access memory (RAM). The auxiliary memory device 103 includes a memory medium such as a hard disk, a flash memory, or the like. Generally, the auxiliary memory device 103 holds a greater amount of data than the main memory device 102. The communication control device 104 may include a network card or a wireless communication module. At least a part of the communication function of the control device 10 with another device may be implemented by the communication control device 104. The input device 105 may include a keyboard, a mouse, a touch panel, a microphone for voice input, and/or the like. The output device 106 may include a display, a printer, and/or the like.

In the auxiliary memory device 103, a program 110 (charging program) and data to be executed are saved in advance. The program 110 causes the computer 100 to execute each functional element of the control device 10. For example, the processing relating to the control method described above is executed in the computer 100 by the program 110. For example, the program 110 is read by the processor 101 or the main memory device 102 and operates at least one of the processor 101, the main memory device 102, the auxiliary memory device 103, the communication control device 104, the input device 105, and the output device 106. For example, the program 110 reads and writes data from and into the main memory device 102 and the auxiliary memory device 103.

The program 110 may be provided after being recorded on a tangible memory medium such as a CD-ROM, a DVD-ROM, or a semiconductor memory, for example. The program 110 may be provided as a data signal via a communication network.

The control device 10 according to one example of the present disclosure sets an internal unit value serving as a unit value of energy available for distribution from the smart grid 2. The control device 10 includes: the acquisition unit 11 configured to acquire an external unit value serving as a unit value of the energy exchanged outside the smart grid 2; the setting unit 12 configured to set a basic internal unit value for the internal unit value by regarding a unit value linked with the external unit value or a predefined unit value as the basic internal unit value; the command reception unit 14 configured to acquire a command generated using an energy remaining amount serving as a remaining amount of the energy inside the smart grid 2; and the correction unit 15 configured to calculate a corrected internal unit value obtained by correcting the internal unit value with acquisition of the command as a trigger, and set the corrected internal unit value for the internal unit value.

The control method according to one example of the present disclosure is executed by the control device 10 including at least one processor. The control method includes: acquiring an external unit value serving as a unit value of energy exchanged outside the smart grid 2; setting a basic internal unit value for an internal unit value serving as a unit value of the energy available for distribution from the smart grid 2, by regarding a unit value linked with the external unit value or a predefined unit value as the basic internal unit value; acquiring a command generated using an energy remaining amount serving as a remaining amount of the energy inside the smart grid 2; and calculating a corrected internal unit value obtained by correcting the internal unit value with acquisition of the command as a trigger, and setting the corrected internal unit value for the internal unit value.

In the control device 10 and the control method, the unit value linked with the external unit value or the predefined unit value is regarded as the basic internal unit value, and the internal unit value is set using the basic internal unit value. Then, with the acquisition of the command as a trigger, the corrected internal unit value with the internal unit value corrected is calculated, and the internal unit value is set using the corrected internal unit value. That is, the internal unit value is dynamically set, so as to set the unit value (e.g., unit price) of energy traded in the smart grid 2 more appropriately.

The internal unit value is a value list indicating unit values for each time of day. The setting unit 12 sets the basic internal unit value for the internal unit value for each time of day. The correction unit 15 calculates the corrected internal unit value obtained by correcting the internal unit value for each time of day and sets the corrected internal unit value for the internal unit value for each time of day. By setting the basic internal unit value and the corrected internal unit value for the internal unit value for each time of day, the unit value of energy can be set more appropriately.

The command has been generated using the energy remaining amount predicted for a future time of day. The correction unit 15 calculates the corrected internal unit value obtained by correcting the internal unit value at the future time of day and sets the corrected internal unit value for the internal unit value at the future time of day. According to such a configuration, the internal unit value at the future time of day is determined in advance so as to more easily schedule a trade of energy with the smart grid and thus improve convenience for the user. In addition, since the unit value (e.g., unit price) of energy can be set more appropriately, the balance between demand and supply of energy can be more easily controlled so as to promote a better distribution of the energy from the smart grid.

The command has been generated when the energy remaining amount indicates a surplus. The correction unit 15 calculates the corrected internal unit value by using a unit value lower than an average of the internal unit values in a predetermined period. According to such a configuration, when the energy remaining amount indicates a surplus, the internal unit value is set lower than the internal unit value set at a normal time. This can encourage the user to supply (e.g., sell) energy in the smart grid 2. Since the unit value (e.g., unit price) of energy can be set more appropriately, the balance between demand and supply of energy can be more easily controlled so as to promote a better distribution of the energy from the smart grid.

For example, in a case where the surplus electric power in the smart grid 2 has a power source with renewable energy, the surplus electric power can be effectively utilized by attracting demand from the user of the smart grid. In particular, when the energy is infeasible to supply from the connection device 4 to the energy source 3, the surplus electric power scheduled to be discarded can be more effectively utilized.

The command has been generated when the energy remaining amount indicates a shortage. The correction unit 15 calculates the corrected internal unit value by using a unit value higher than an average of the internal unit values in a predetermined period. According to such a configuration, when the energy remaining amount indicates a shortage, the internal unit value is set higher than the internal unit value set at a normal time. This can encourage the user to supply (e.g., purchase) energy in the smart grid 2. Since the unit value (e.g., unit price) of energy can be set more appropriately, the balance between demand and supply of energy can be more easily controlled so as to promote a better distribution of the energy from the smart grid.

The control device 10 further includes a transmission unit configured to transmit the internal unit value to a terminal of the user in response to setting of the corrected internal unit value for the internal unit value. This can encourage the user to transfer energy between the smart grid 2 and the user device 20, for example via a sale or purchase of the energy. Since the unit value (e.g., unit price) of energy can be set more appropriately, the balance between demand and supply of energy can be more easily controlled so as to promote a better distribution of the energy from the smart grid.

The energy includes electric power, hydrogen, ammonia, or heat. Examples of the control device 10 described herein can support various energy pay-per-use schemes.

### ADDITIONAL EXAMPLES

It is to be understood that not all aspects, advantages and features described herein may necessarily be achieved by, or included in, any one particular example. Indeed, having described and illustrated various examples herein, it should be apparent that other examples may be modified in arrangement and detail.

For example, the generation device 5 may not be a facility in the smart grid 2. In the present disclosure, the smart grid controller 9 and the control device 10 have been described as separate components, but are not restricted to this. For example, the smart grid controller 9 may include some or all of the respective functional elements of the control device 10.

In the present disclosure, for example, in a case where the energy is hydrogen or ammonia, the storage device 6 may be a tank that stores hydrogen or ammonia. The smart grid controller 9 may acquire a hydrogen amount or an ammonia amount as the energy remaining amount. In a case where the energy is heat, the storage device 6 may be a boiler or the like.

The smart grid controller 9 may correct or learn the command generation condition by feedback. For example, the smart grid controller 9 may compare the energy remaining amount predicted for a future time of day with the actual energy remaining amount. On the basis of the result of the comparison, the smart grid controller 9 may adjust the threshold for generating the command.

In the present disclosure, the expression “at least one processor executes a first process, a second process, . . . , and an n-th process” or an expression corresponding to the above represents a concept including a case where executing entities (that is, the processors) for n processes from the first process to the n-th process are switched in the middle of the processes. That is, this expression represents a concept including both of a case where all the n processes are executed by the same processor and a case where the processors are switched according to any policy during the n processes.

The processing procedure of the method executed by at least one processor is not limited to the example in the present disclosure. For example, some of the steps (processes) described above may be omitted, or the respective steps may be executed in another order. In addition, any two or more steps of the above-described steps may be combined, or some steps may be adapted or deleted. Alternatively, another step may be executed in addition to the above-described steps.

The present disclosure describes a technique for appropriately setting a unit value of energy in a smart grid to more efficiently adjust the balance between demand and supply of energy. For this reason, the technique described herein contributes also to the following goal of the United Nations-led sustainable development goals (SDGs).

Goal 7 “Ensure access to affordable, reliable, sustainable and modern energy for all”

Examples of the present disclosure will be described below.

### Example <1>

A charging device configured to set an internal unit value serving as a unit value of energy available for distribution from a smart grid, the charging device including:
an acquisition unit configured to acquire an external unit value serving as a unit value of the energy supplied outside the smart grid;
a setting unit configured to set a basic internal unit value for the internal unit value by regarding a unit value linked with the external unit value or a predefined unit value as the basic internal unit value;
a command reception unit configured to acquire a command generated using an energy remaining amount serving as a remaining amount of the energy inside the smart grid; and
a correction unit configured to calculate a corrected internal unit value obtained by correcting the internal unit value with acquisition of the command as a trigger, and set the corrected internal unit value for the internal unit value.

### Example <2>

The charging device according to example <1>, in which
the internal unit value is a value list indicating unit values for each of times of day,
the setting unit sets the basic internal unit value for the internal unit value for each of the times of day, and
the correction unit calculates the corrected internal unit value obtained by correcting the internal unit value for each of the times of day, and sets the corrected internal unit value for the internal unit value for each of the times of day.

### Example <3>

The charging device according to example <2>, in which
the command has been generated using the energy remaining amount predicted for a future time of day, and
the correction unit calculates the corrected internal unit value obtained by correcting the internal unit value at the future time of day, and sets the corrected internal unit value for the internal unit value at the future time of day.

### Example <4>

The charging device according to any one of examples <1> to <3>, in which
the command has been generated when the energy remaining amount indicates a surplus, and
the correction unit calculates the corrected internal unit value by using a unit value lower than an average of the internal unit values in a predetermined period.

### Example <5>

The charging device according to any one of examples <1> to <3>, in which
the command has been generated when the energy remaining amount indicates a shortage, and
the correction unit calculates the corrected internal unit value by using a unit value higher than an average of the internal unit values in a predetermined period.

### Example <6>

The charging device according to any one of examples <1> to <5>,
the charging device further including a transmission unit configured to transmit the internal unit value to a terminal of a user of the energy in response to setting of the corrected internal unit value for the internal unit value.

### Example <7>

The charging device according to any one of examples <1> to <6>, in which the energy includes electric power, hydrogen, ammonia, or heat.

### Example <8>

A charging method executed by a charging device including at least one processor, the charging method including:
acquiring an external unit value serving as a unit value of energy supplied outside a smart grid;
setting a basic internal unit value for an internal unit value serving as a unit value of the energy available for distribution from the smart grid, by regarding a unit value linked with the external unit value or a predefined unit value as the basic internal unit value;
acquiring a command generated using an energy remaining amount serving as a remaining amount of the energy inside the smart grid; and
calculating a corrected internal unit value obtained by correcting the internal unit value with acquisition of the command as a trigger, and setting the corrected internal unit value for the internal unit value.

1. A smart grid system for controlling a supply of energy to a plurality of user devices, the system comprising:
an energy supply device configured to obtain energy from an external energy source, wherein the energy is assigned an external energy unit value;
a storage device configured to temporarily store the energy for distribution to the plurality of user devices;
at least one control device configured to:
set an internal energy unit value based on either the external energy unit value or a predefined unit value;
acquire a trigger command based on an amount of energy stored in the storage device; and
modify the internal energy unit value in response to acquiring the trigger command; and
a filling device configured to distribute the energy to the plurality of user devices at the modified internal energy unit value.

2. The smart grid system according to claim 1, wherein the at least one control device is further configured to:
acquire an energy remaining amount that is available in the smart grid system to distribute via the filling device, wherein the energy remaining amount is set based on the amount of energy stored in the storage device; and
generate the trigger command, in response to determining that the energy remaining amount is outside of a predetermined range.

3. The smart grid system according to claim 2, further comprising:
a generation device configured to generate energy within the smart grid system; and
a system load that causes energy to be consumed within the smart grid system,
wherein the energy remaining amount is additionally set based on at least one of an amount of energy detected in the generation device, or an amount of energy consumption by the system load.

4. The smart grid system according to claim 1, wherein the at least one control device is further configured to:
set an output value based on the modified internal energy unit value; and
transmit the output value over a communication network, to be dynamically displayed on a display screen of a terminal in response to modifying the internal energy unit value.

5. The smart grid system according to claim 1, further comprising a display screen that is configured to display an output value that corresponds to the modified internal energy unit value, or to a difference between the internal energy unit value that is initially set and the modified internal energy unit value.

6. The smart grid system according to claim 1, wherein the at least one control device is further configured to:
determine an energy remaining amount that is predicted to be available to distribute via the filling device at a future time, based on the amount of energy stored in the storage device; and
generate the trigger command based on the energy remaining amount,
wherein the at least one control device includes a memory device configured to store the internal energy unit value in a list of internal energy unit values in association with time intervals of a day, and
wherein the internal energy unit value that is modified is associated with a time interval that corresponds to the future time.

7. The smart grid system according to claim 6, wherein the at least one control device is further configured to:
set a time period based on the future time of the energy remaining amount;
select internal energy unit values from the list, that are associated with time intervals within the time period; and
modify the internal energy unit values selected from the list based on the energy remaining amount.

8. The smart grid system according to claim 7, wherein the at least one control device is further configured to:
determine an average of the internal energy unit values selected from the list in association with the time period; and
selectively modify the internal energy unit value to be less than the average in response to the energy remaining amount indicating an energy surplus, or to be greater than the average in response to the energy remaining amount indicating an energy shortage.

9. The smart grid system according to claim 7, wherein the internal energy unit values are further stored in the memory device in association with a linkage setting for each of the time intervals,
wherein each of the selected internal energy unit values that is indicated as having a linkage setting that is activated, is initially set in the list based on the external energy unit value, and
wherein each of the selected internal energy unit values that is indicated as having a linkage setting that is deactivated is initially set in the list to the predefined unit value.

10. The smart grid system according to claim 1, wherein the at least one control device is further configured to:
acquire an energy remaining amount that is predicted to be available to distribute via the filling device at a future time, based on the available amount of energy stored in the storage device, and
selectively modify the internal energy unit value that corresponds to the future time, to be reduced in response to the energy remaining amount indicating an energy surplus, or to be increased in response to the energy remaining amount indicating an energy shortage.

11. A method of controlling a supply of energy from a smart grid to a plurality of user devices, the method comprising:
acquiring an external energy unit value from an external energy source;
setting an internal energy unit value of internal energy available within the smart grid to supply the plurality of user devices, based on either the external energy unit value or a predefined unit value;
acquiring a trigger command based on an amount of energy stored in a storage device of the smart grid;
modifying the internal energy unit value in response to acquiring the trigger command; and
distributing the energy to at least one of the plurality of user devices at the modified internal energy unit value.

12. The method according to claim 11, further comprising:
acquiring an energy remaining amount that is available in the smart grid to distribute to the plurality of user devices, wherein the energy remaining amount is set based on the amount of energy stored in the storage device; and
generating the trigger command, in response to determining that the energy remaining amount is outside of a predetermined range.

13. The method according to claim 12, wherein the energy remaining amount is additionally set based on at least one of an amount of energy detected in a generation device of the smart grid, or an amount of energy consumption by a system load of the smart grid.

14. The method according to claim 11, further comprising:
setting an output value based on the modified internal energy unit value; and
transmitting the output value over a communication network, to be dynamically displayed on a display screen of a terminal.

15. The method according to claim 11, further comprising displaying an output value that corresponds to the modified internal energy unit value, or to a difference between the internal energy unit value that is initially set and the modified internal energy unit value.

16. The method according to claim 11, further comprising:
determining an energy remaining amount that is predicted to be available in the smart grid for distribution at a future time, based on an amount of energy stored in the storage device; and
generating the trigger command based on the energy remaining amount,
wherein the internal energy unit value is stored in a list of internal energy unit values in association with time intervals of a day, and
wherein the internal energy unit value that is modified is associated with a time interval that corresponds to the future time.

17. The method according to claim 16, further comprising:
setting a time period based on the future time of the energy remaining amount;
selecting internal energy unit values from the list, that are associated with time intervals within the time period; and
modifying the internal energy unit values selected from the list based on the energy remaining amount.

18. The method according to claim 17, further comprising:
determining an average of the internal energy unit values selected from the list in association with the time period; and
selectively modifying the internal energy unit value to be less than the average in response to the energy remaining amount indicating an energy surplus, or to be greater than the average in response to the energy remaining amount indicating an energy shortage.

19. The method according to claim 17, wherein the internal energy unit values in the list are further associated with a linkage setting for each of the time intervals,
wherein each of the selected internal energy unit values that is indicated as having a linkage setting that is activated, is initially set in the list based on the external energy unit value, and
wherein each of the selected internal energy unit values that is indicated as having a linkage setting that is deactivated is initially set in the list to the predefined unit value.

20. The method according to claim 11, further comprising:
acquiring an energy remaining amount that is predicted to be available to distribute at a future time, based on the available amount of energy stored in the storage device; and
selectively modifying the internal energy unit value that corresponds to the future time, to be reduced in response to the energy remaining amount indicating an energy surplus, or to be increased in response to the energy remaining amount indicating an energy shortage.
